(19) United States
(12) Patent Application Publication
(10) Pub. No.: US 2017/0074219 A1
(43) Pub. Date: Mar. 16, 2017

(54) INTAKE MANIFOLD WITH IMPACT STRESS CONCENTRATOR

(71) Applicant: FORD GLOBAL TECHNOLOGIES, LLC, Dearborn, MI (US)

(72) Inventor: Gary Nola, Detroit, MI (US)

(21) Appl. No.: 14/854,895

(22) Filed: Sep. 15, 2015

(51) Int. Cl. F02M 35/104

(52) U.S. Cl. CPC F02M 35/104

(57) ABSTRACT

An intake manifold is provided. That intake manifold includes a body having at least one runner and an impact stress concentrator projecting outwardly from the at least one runner.

### TECHNICAL FIELD

This document relates generally to the motor vehicle equipment field and, more specifically, to an intake manifold incorporating an impact stress concentrator that influences crushing characteristics to absorb crash energy.

### BACKGROUND

This document relates to a new and improved intake manifold that incorporates an impact stress concentrator that projects outwardly from a front face of the intake manifold. Advantageously, such an intake manifold is designed to have increased crushability, thereby better dissipating impact energy from a frontal collision. Thus, the novel intake manifold described herein increases crash safety of a motor vehicle incorporating the intake manifold. Additionally, by absorbing crash energy, the intake manifold disclosed herein potentially reduces damage to other engine compartment components located rearwardly of the intake manifold, thereby reducing vehicle repair costs following a frontal collision. Thus, it should be appreciated that the intake manifold disclosed herein represents a significant advance in the art.

### SUMMARY

In accordance with the purposes and benefits described herein, an intake manifold is provided. That intake manifold comprises a body including at least one runner and an impact stress concentrator projecting outwardly from that at least one runner. More specifically, in one possible embodiment the at least one runner includes a face oriented vehicle forward and the impact stress concentrator projects forwardly from that face.

More specifically, in one possible embodiment the impact stress concentrator is a rib carried on the at least one runner. That rib includes a plurality of spaced notches. Each notch of the plurality of spaced notches may be substantially V-shaped.

In one possible embodiment, the rib extends continuously along the at least one runner for a length between about 150 mm and about 200 mm. In one possible embodiment, the plurality of notches are spaced from each other by a distance of between about 20 mm and about 30 mm. In one possible embodiment, the rib has an overall height of between about 10 mm and about 20 mm and an overall thickness of between about 3 mm and 5 mm. Further, each notch of the plurality of notches has a width of between about 3 mm and about 5 mm at a wide end thereof and a depth of between about 2 mm and about 4 mm.

In accordance with an additional aspect, the intake manifold may be described as comprising an intake plenum, a first intake runner, a second intake runner, a third intake runner, a fourth intake runner and an impact stress concentrator. That impact stress concentrator projects outwardly from the four intake runners so as to effectively provide a first point of contact and functions to concentrate collision impact forces upon a smaller area, thereby increasing stress in the smaller area and thus providing the intake manifold with an engineered crush zone.

In accordance with still another aspect, a method is provided for producing an intake manifold with a crush zone. That method may be broadly described as comprising the step of providing an impact stress concentrator projecting outwardly from a face of the intake manifold. Such a stress concentrator acts as a first point of contact to concentrate collision impact forces to a smaller area, thereby increasing stress in the smaller area and thus forming a crush zone.

In one possible embodiment, the method further includes providing an elongated rib along a front face of the intake manifold to act as the impact stress concentrator. Further, the method may include providing a plurality of notches on the elongated rib at spaced locations so as to weaken the rib and promote controlled bending in response to collision impact forces. Still further, the method may include extending the elongated rib along a length of an intake runner of the intake manifold.

In the following description, there are shown and described several preferred embodiments of the intake manifold. As it should be realized, the intake manifold is capable of other, different embodiments and its several details are capable of modification in various, obvious aspects all without departing from the intake manifold as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the intake manifold and together with the description serve to explain certain principles thereof. In the drawing figures:

FIG. 1 is a schematic top plan view of the engine compartment of a motor vehicle incorporating the intake manifold that is the subject matter of this document.

FIG. 2 is a detailed perspective view of the intake manifold clearly showing the impact stress concentrator in the form of a series of ribs that extend continuously along the runners of the intake manifold.

FIG. 3A is a detailed perspective view illustrating one of the V-shaped notches along the ribs that effectively weaken the ribs and provide for controlled bending of the ribs and the intake manifold in response to frontal collision impact forces.

FIG. 3B is a detailed perspective view illustrating one of V-shaped notches following application of a frontal collision impact force.

FIG. 4 is a perspective view of the intake manifold illustrating the crushability provided by the designed or engineered crush zone of the intake manifold.

Reference will now be made in detail to the present preferred embodiments of the intake manifold, examples of which are illustrated in the accompanying drawing figures.

### DETAILED DESCRIPTION

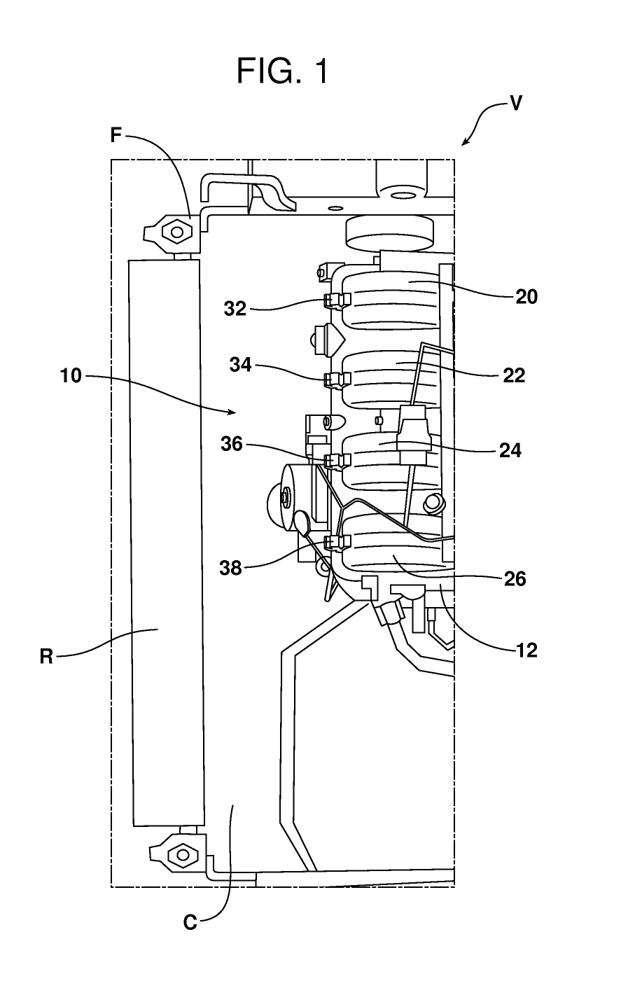

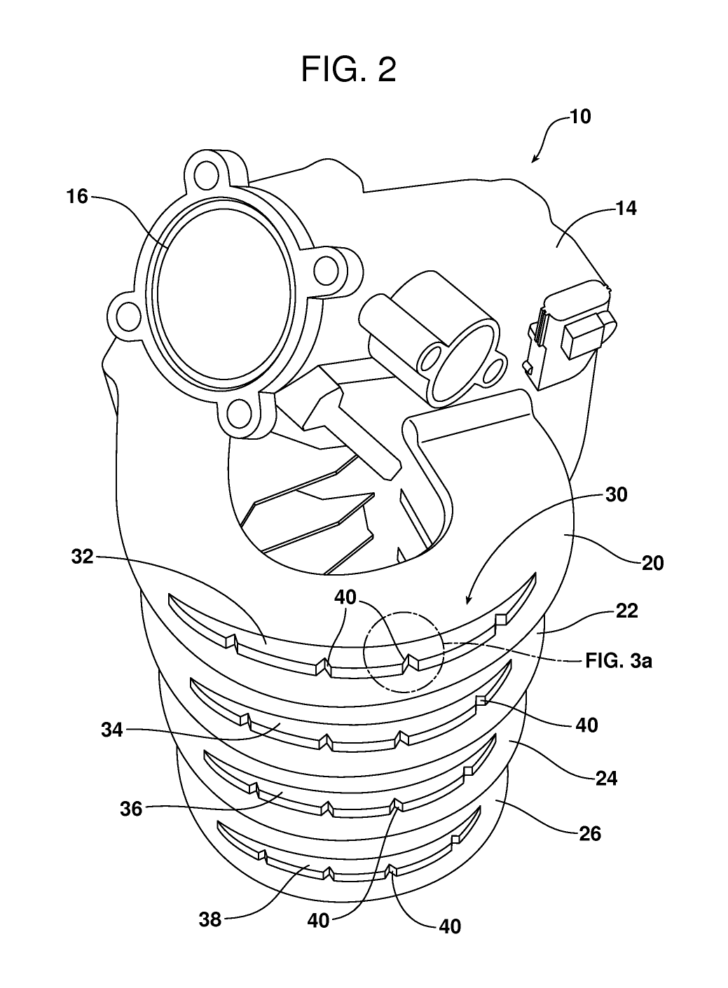

Reference is now made to FIGS. 1 and 2 illustrating the engine compartment C of a motor vehicle V including the intake manifold 10 that is the subject matter of this document. More specifically, the intake manifold 10 is connected between the throttle body and the combustion chambers (not shown) of the motor vehicle engine 12. In the illustrated embodiment, intake air first passes from the throttle body into the intake manifold plenum 14 through the inlet 16. A first runner 20 directs intake air from the plenum 14 to the first combustion chamber. Similarly, second, third and fourth runners 22, 24, 26 direct intake air from the plenum 14 to the second, third and fourth combustion chambers. Thus, in the illustrated embodiment, the four runners 20, 22, 24, 26 form four separate and discrete air pathways between the plenum 14 and the four cylinders.

As best illustrated in FIG. 2, the body of the intake manifold 10 includes an impact stress concentrator generally designated by reference numeral 30. In the illustrated embodiment, the impact stress concentrator 30 comprises a first rib 32 extending along the first runner 20, a second rib 34 extending along the second runner 22, a third rib 36 extending along the third runner 24 and a fourth rib 38 extending along the fourth runner 26. More specifically, the ribs 32, 34, 36, 38 are provided on the front faces of the respective runners 20, 22, 24, 26 and oriented vehicle forward (that is, toward the vehicle radiator R (see FIG. 1)).

As illustrated, each rib 32, 34, 36, 38 includes a plurality of spaced notches 40. In the illustrated embodiment, the notches 40 are V-shaped. Further, as illustrated each rib 32, 34, 36, 38 extends along the length of instead of across each associated runner 20, 22, 24, 26. The plurality of notches 40 may be spaced from each other by a distance of between about 20 mm and about 30 mm along the ribs 32, 34, 36, 38. In one possible embodiment, the ribs may have an overall height of between about 10 mm and about 20 mm and an overall thickness of between about 3 mm and about 5 mm. Further, the notches 40 each may have a width of between about 3 mm and about 5 mm at a wide end thereof and a depth of between about 2 mm and about 4 mm. In addition, each rib 32, 34, 36, 38 may have a height of between about 10 mm and about 20 mm. In one possible embodiment, the depth of the notch 40 relative to the rib 32, 34, 36, 38 height is a ratio between 0.5 to one and 0.15 to one. Here it should be appreciated that these values are exemplary of certain embodiments of the ribs 32, 34, 36, 38 of the impact stress concentrator 30 but the ribs are not limited thereto.

As should be appreciated from viewing FIGS. 1 and 2, the ribs 32,34,36,38 project forwardly of the forward face of the runners 20, 22, 24, 26 toward the radiator R and radiator support frame F. Thus, the ribs 32, 34, 36, 38 that form the impact stress concentrator 30 provide one or more first points of contact to concentrate collision impact forces upon a smaller area of the intake manifold 10, thereby increasing stress in a smaller area and thus providing the intake manifold with a designed or engineered crush zone in the event a front end collision of the motor vehicle V.

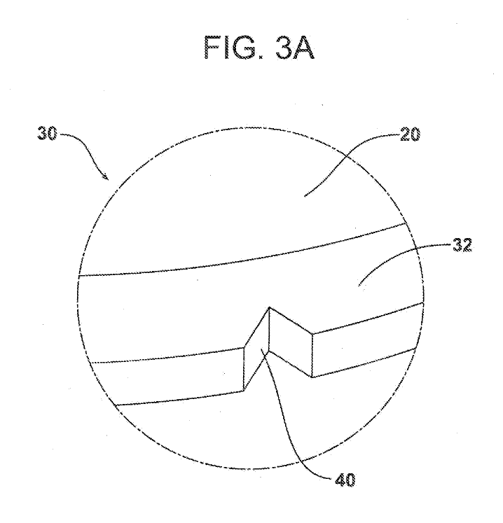

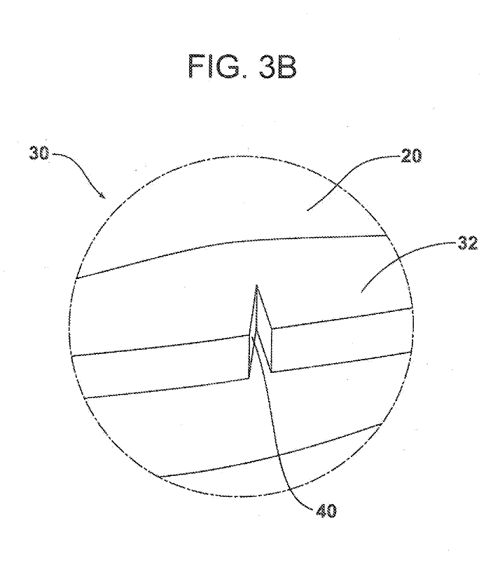

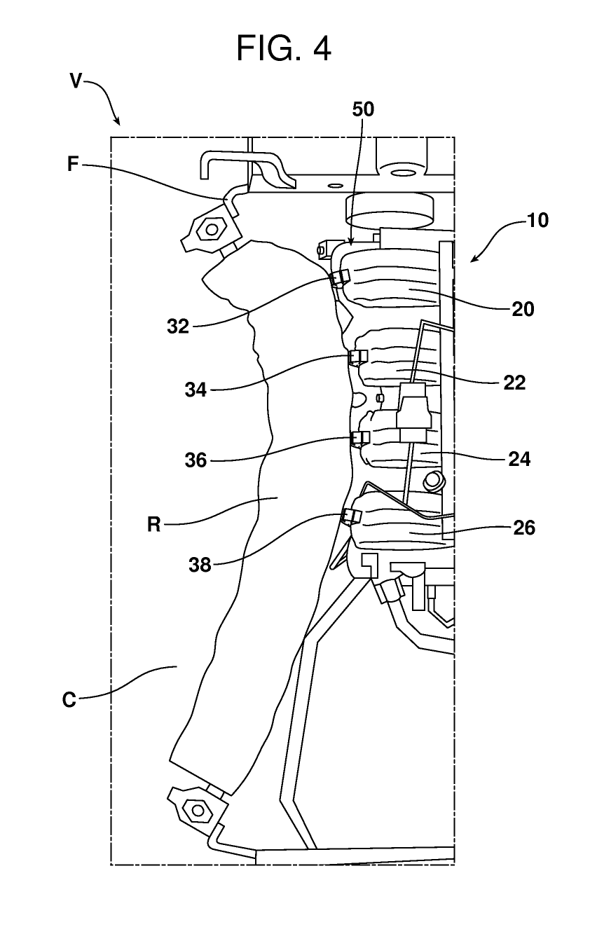

Reference is now made to FIGS. 3A, 3B and 4, illustrating how the ribs 32, 34, 36, 38 function as first points of contact and provide a designed crushability to the intake manifold 10 that functions to absorb impact energy, dissipating that energy and increasing vehicle safety.

As illustrated in FIG. 4, in the event of a frontal collision wherein the radiator R and radiator support frame F are driven rearwardly into the intake manifold 10, the radiator R and/or radiator support frame F make first contact with one or more of the ribs 32, 34, 36, 38. As a consequence, the ribs 32, 34, 36, 38 function to concentrate the impact stress on the intake manifold 10 along the length of the ribs 32, 34, 36, 38. The notches 40 that are provided in the ribs 32, 34, 36, 38 function to weaken the ribs at the notches so as to initiate a controlled bending or collapsing of the ribs and the intake manifold 10 at the rib locations (see FIG. 3B showing bending a V-shaped rib 40 and crushing of runner 20 when compared to FIG. 3A). As a consequence, the intake manifold is designed with a crush zone 50 characterized by controlled crushability. FIG. 4 illustrates one possible embodiment of the intake manifold 10 engineered to crush in the manner illustrated and described. It should be appreciated that as the intake manifold 10 is crushed and collapses, frontal collision impact energy is dissipated. Not only does this serve to increase vehicle safety, but it also functions to potentially reduce or limit damage to components of the motor vehicle in the engine compartment rearward of the intake manifold 10. Thus, the crush zone 50 of the intake manifold 10 also has the potential for reducing motor vehicle repair costs following a frontal collision.

As should be appreciated, a method of providing an intake manifold 10 with an engineered crush zone 50 is also disclosed. That method may be broadly described as including the step of providing an impact stress concentrator 30 projecting outwardly from a face of the intake manifold 10 whereby the impact stress concentrator acts as a first point of contact to concentrate collision impact forces to a smaller area, thereby increasing stress in the smaller area and thus forming the crush zone 50.

The method may be further and more particularly described as also providing elongated ribs 32, 34, 36, 38 on the front face of the intake manifold 10 to act as the impact stress concentrator 30. Further, the method may include the step of providing a plurality of notches 40 on the elongated ribs 32, 34, 36, 38 at spaced locations so as to weaken the rib and promote controlled bending response to collision impact forces.

Still further, the method may include extending the elongated ribs 32, 34, 36, 38 along a length of the intake runner 20, 22, 24, 26 of the intake manifold 10 as necessary to provide the desired design crushability and crush zone 50.

The foregoing has been presented for purposes of illustration and description. It is not intended to be exhaustive or to limit the embodiments to the precise form disclosed. Obvious modifications and variations are possible in light of the above teachings. For example, the notches 40 may assume another shape besides the V-shape described above and illustrated in the drawing figures. The height and thickness of the ribs 32, 34, 36, 38 may be varied from that disclosed above. In essence, these and other parameters may be individually selected to tune the performance characteristics of the impact stress concentrator 30 to provide the desired crushability and crush zone 50 for any particular application.

Further, while an intake manifold 10 with four runners 20, 22, 24, 26 for a four-cylinder engine is illustrated, it should be appreciated that the intake manifold 10 may incorporate any number of runners to match the number of cylinders of the engine to which the intake manifold 10 is mounted. All such modifications and variations are within the scope of the appended claims when interpreted in accordance with the breadth to which they are fairly, legally and equitably entitled.

What is claimed:

1. An intake manifold, comprising:
a body including at least one runner; and
an impact stress concentrator projecting outwardly from said at least one runner.

2. The intake manifold of claim 1, wherein said at least one runner includes a face oriented vehicle forward and said impact stress concentrator projects forwardly from said face.

3. The intake manifold of claim 2, wherein said impact stress concentrator is a rib carried on said at least one runner.

4. The intake manifold of claim 3, wherein said rib includes a plurality of spaced notches.

5. The intake manifold of claim 4, wherein each notch of said plurality of spaced notches is substantially V-shaped.

6. The intake manifold of claim 5, wherein said rib extends continuously along said at least one runner for a length of between 150 mm and 200 mm.

7. The intake manifold of claim 6, wherein said plurality of notches are spaced from each other by a distance of between about 20 mm and about 30 mm.

8. The intake manifold of claim 7, wherein said rib has an overall height of between about 10 mm and about 20 mm and an overall thickness of between about 3 mm and about 5 mm.

9. The intake manifold of claim 8, wherein each notch of said plurality of notches has a width of between about 3 mm and about 5 mm at a wide end thereof and a depth of between about 2 mm and about 4 mm.

10. An intake manifold, comprising:
an intake plenum;
a first intake runner;
a second intake runner;
a third intake runner;
a fourth intake runner; and
an impact stress concentrator projecting outwardly from said first intake runner, said second intake runner, said third intake runner and said fourth intake runner whereby said impact stress concentrator provides a first point of contact to concentrate collision impact forces upon a smaller area, thereby increasing stress in said smaller area and thus providing said intake manifold with a crush zone.

11. The intake manifold of claim 10, wherein said impact stress concentrator includes a first rib extending along said first intake runner, a second rib extending along said second intake runner, a third rib extending along said third intake runner and a fourth rib extending along said fourth intake runner.

12. The intake manifold of claim 11, wherein first rib includes a first plurality of notches, said second rib includes a second plurality of notches, said third rib includes a third plurality of notches and said fourth rib includes a fourth plurality of notches.

13. The intake manifold of claim 12, wherein said first plurality of notches, said second plurality of notches, said third plurality of notches and said fourth plurality of notches are substantially V-shaped.

14. The intake manifold of claim 13, wherein said notches of said first plurality of notches are spaced apart by a distance of between about 20 mm and about 30 mm.

15. The intake manifold of claim 14, wherein said notches of said first plurality of notches have a depth of between about 2 mm and about 4 mm.

16. The intake manifold of claim 15, wherein said first rib has an overall height of between about 10 mm and about 20 mm and a thickness of between about 3 mm and about 5 mm.

17. A method of providing an intake manifold with a crush zone, comprising:
providing an impact stress concentrator projecting outwardly from a face of said intake manifold whereby said impact stress concentrator acts as a first point of contact to concentrate collision impact forces to a smaller area thereby increasing stress in said smaller area and thus forming said crush zone.

18. The method of claim 17, including providing an elongated rib along a front face of said intake manifold to act as said impact stress concentrator.

19. The method of claim 18, including providing a plurality of notches on said elongated rib at spaced locations so as to weaken said rib and promote controlled bending in response to collision impact forces.

20. The method of claim 18, including extending said elongated rib along a length of an intake runner of said intake manifold.
